(19) United States
(12) Patent Application Publication
(10) Pub. No.: US 2025/0385362 A1
(43) Pub. Date: Dec. 18, 2025

(54) Electrical Energy Store for a Motor Vehicle, in Particular for an Automobile, and Motor Vehicle

(71) Applicant: Bayerische Motoren Werke Aktiengesellschaft, Muenchen (DE)

(72) Inventors: Florian BECK, Freising (DE); Thomas HARSCH, Muenchen (DE); Dominic MUELLER, Buxheim (DE); Florian SOLDNER, Brannenburg (DE)

(21) Appl. No.: 18/867,492

(22) PCT Filed: Jul. 27, 2023
(86) PCT No.: PCT/EP2023/070882

§ 371 Date: Nov. 20, 2024

(30) Foreign Application Priority Data
Jul. 27, 2022 (DE) 10 2022 118 836.1

(51) Int. Cl. H01M 50/242; B60L 50/64; H01M 50/204; H01M 50/249; H01M 50/278; H01M 50/289

(52) U.S. Cl. CPC H01M 50/242; B60L 50/64; H01M 50/204; H01M 50/249; H01M 50/278; H01M 50/289; H01M 2220/20

(57) ABSTRACT

An electrical energy store for a motor vehicle has storage cells designed to store electrical energy, which are arranged in a store housing which has a base having an upper base element and a lower base element, wherein the separately formed base elements can be detached from one another in a non-destructive manner, at least with respect to the base elements.

### BACKGROUND AND SUMMARY

The invention relates to an electrical energy store for a motor vehicle, in particular for an automobile. Furthermore, the invention relates to a motor vehicle, in particular an automobile, comprising such an electrical energy store.

Known from WO 2021/105328 A1 is a battery housing for a motor vehicle driven by an electric motor, to be installed in a base region of the vehicle. The battery housing has a frame enclosing at least one battery module, and has a base that is connected to the frame and is equipped with a collision protection and realized as a sandwich construction, comprising a lower metal plate, an upper metal plate spaced apart from the lower metal plate, and a structural metal plate located in between and connected to the lower metal plate and the upper metal plate. Furthermore, DE 10 2016 213 832 B4 discloses a lower shell for a battery housing. A battery carrier is also known from DE 10 2016 115 611 B3.

The object of the present invention is to create an electrical energy store, and a motor vehicle comprising such an electrical energy store, such that a particularly advantageous repair of the electrical energy store may be realized.

This object is achieved according to the invention by an electrical energy store and by a motor vehicle having the features of the independent claim(s). Advantageous designs of the invention are provided by the dependent claims.

A first aspect of the invention relates to an electrical energy store, also referred to simply as an energy store or store, for a motor vehicle that may preferably be realized as an automobile, in particular as a passenger car. This means that, in its completed production state, the motor vehicle, which is also referred to simply as a vehicle, comprises the electrical energy store, in or by means of which electrical energy is to be stored or is stored, in particular electrochemically. In particular, the motor vehicle in its completed production state has at least one electrical machine by means of which the motor vehicle can be driven, in particular purely electrically. The motor vehicle is thus preferably realized as a hybrid vehicle or, alternatively, as an electric vehicle, in particular as a battery electric vehicle (BEV). The electrical machine may be supplied with the electrical energy stored in the electrical energy store, enabling the electrical machine to be operated in motor mode, and thus as an electric motor. By means of the electric motor, the motor vehicle can be driven electrically, in particular purely electrically. The electrical energy store and/or the electrical machine are/is preferably realized as a high-voltage component, the voltage, in particular operating or rated voltage, of which is preferably greater than 50 volts, in particular greater than 60 volts, and is very preferably several hundred volts. The electrical energy store is thus preferably realized as a so-called high-voltage store, in particular as a so-called high-voltage battery (HV battery).

The electrical energy store has storage cells, also referred to simply as cells. By means of the storage cells, the aforementioned electrical energy can be stored, in particular electrochemically. In particular, the storage cells are connected to each other, for example electrically. The electrical energy store additionally has a store housing, also referred to simply as a housing, in which the storage cells are arranged. For this purpose, a receiving region is delimited, in particular directly, for example by the store housing. In each case, the storage cells are arranged at least partially, in particular at least predominantly and thus at least by more than half or completely, in the receiving region. The receiving region is a receiving space, or is also referred to as a receiving space.

The store housing has a base by which, for example when the electrical energy store is in the installed position, the receiving region is delimited downward at least predominantly and thus by at least more than half, in particular completely, in the vertical direction of the motor vehicle. In other words, when the electrical energy store is in the installed position, the receiving region is at least predominantly and thus by at least more than half or, alternatively, completely overlapped downward in the vertical direction of the motor vehicle. In particular, it is contemplated, when the electrical energy store is in the installed position, for the storage cells to be at least predominantly and thus by at least more than half or, alternatively completely overlapped downward by the base, and thereby covered, in the vertical direction of the motor vehicle. The electrical energy store assumes its installed position when the motor vehicle is in the completed production state, equipped with the electrical energy store. The base is also referred to as the housing base. The base has an upper base element and a lower base element. This is to be understood to mean, in particular, that when the electrical energy store is in the installed position, the upper base element is arranged above the lower base element in the vertical direction of the vehicle, i.e. arranged further up than the lower base element in the vertical direction of the vehicle, in particular in such a way that, when the electrical energy store is in the installed position, the upper base element is at least predominantly and thus by at least more than half or, alternatively, completely overlapped downward by the lower base element in the vertical direction of the vehicle. Accordingly, when the electrical energy store is in the installed position, the lower base element is arranged beneath the upper base element, or is arranged further down than the upper base element, as viewed in the vertical direction of the vehicle, in particular in such a way that, when the electrical energy store is in the installed position, the lower base element is at least predominantly and thus by at least more than half or, alternatively, completely covered and thus overlapped by the upper base element in the vertical direction of the vehicle. Thus, the upper base element, in particular when the electrical energy store is in the installed position, is arranged between the storage cells and the lower base element, as viewed in the vertical direction of the vehicle.

In order then to repair the electrical energy store, and thus the motor vehicle as a whole, in a particularly advantageous manner, in particular in a particularly time-saving and cost-effective manner, i.e. to enable it to undergo repair, it is provided according to the invention that the base elements, which are realized separately from each other, can be detached in a non-destructive manner at least with regard to the base elements, and are thus connected to each other, for example at least indirectly, in particular directly. This means that the base elements can be detached from each other and, thereupon, reconnected to each other at least indirectly and, in particular thereupon, detached from each other again without damaging or destroying the base elements.

When the motor vehicle is in its completed production state, for example the base, in particular the store housing and, most particularly, the electrical energy store, is held on a superstructure of the motor vehicle, for example realized as a self-supporting body, the interior of which, also referred to as the passenger cell or passenger compartment, is formed or delimited, for example, by the body. In this case, for example, the base is arranged in a base region of the motor vehicle, in particular of the body, in particular in such a way that, in the vertical direction of the vehicle, a superstructure base of the superstructure, also referred to as the body floor or main floor, is arranged between the base and the interior with, for example, the main floor being at least partially, in particular at least predominantly and thus by at least more than half or, alternatively, completely, overlapped by the base of the electrical energy store, as viewed downward in the vertical direction of the vehicle. In the following, unless otherwise specified, the term base is to be understood to mean the base of the electrical energy store.

The fact that the base elements are detachably connected to each other in a non-destructive manner makes it possible to detach and remove the lower base element from the upper base element without destroying or damaging the base elements and, in particular, while the upper base element and, for example, also the storage cells remain on the superstructure of the motor vehicle and are therefore retained. This means that, for example, in the event of the lower base element being damaged or destroyed, in particular due to an accident, the storage cells and the entire base do not have to be detached from the superstructure and replaced, but it is sufficient, for example, to detach the lower base element from the upper base element and from the superstructure and replace it with a new, undamaged base element, while the upper base element and the storage cells remain attached to the superstructure and may be used further.

The invention is based, in particular, on the knowledge that in the case of conventional solutions, if a sub-base formed, for example, by the lower base element, is damaged, the entire electrical energy store must be replaced, in particular below a lift-out limit. This can be very cost-intensive, in particular if the storage cells are adhesive-bonded and/or foam-bonded to the store housing and it is not possible to replace just the store housing separately. Additionally, it is possible for the electrical energy store, or the store housing, to be adhesive-bonded to the superstructure, in particular directly, which makes replacement impossible or even more costly. Overall, if the lower base element is damaged, this can result in very high costs. These problems and disadvantages can now be avoided by the invention.

In order to realize a particularly advantageous accident behavior and a particularly high degree of rigidity of the electrical energy store despite the base elements being detachably connected to each other in a non-destructive manner, it is provided in one embodiment of the invention that the storage cells are supported on the upper base element by means of a support structure realized between the upper base element and the storage cells and preferably separately from the storage cells and separately from the upper base element. Preferably, the support structure is also realized separately from the lower base element. For example, the support structure may be made of a plastic, such that the support structure may be realized, for example, as a plastic structure. Alternatively, the support structure may be made of a metallic material, such that the support structure may be realized, for example, as a metal structure. For example, the metallic material is a metal foam or a metal mesh, in particular a metal fabric. The support structure may also have honeycombs, for example, and thus be realized as a honeycomb structure. For example, the support structure has an intermediate region that, in particular when the electrical energy store is in the installed position, is arranged between the storage cells and the upper base element, in the vertical direction of the vehicle. The support structure, in particular the intermediate region, may be in particular, for example, a particularly compact support, in particular a metal support or plastic support. The support is also referred to as a structural support. It is conceivable in this case for the storage cells to be adhesive-bonded to the upper base element via the support. For this purpose, it is conceivable for the storage cells to be adhesive-bonded and/or foam-bonded to the support, in particular directly, and/or for the support to be adhesive-bonded and/or foam-bonded to the upper base element, in particular directly. The support is thus made of the aforementioned plastic or of the aforementioned metallic material.

Preferably, the support structure is realized as a single piece, i.e. formed from one single piece. Or, in other words, it is preferably provided that the support structure is realized as a monoblock or is formed by a monoblock, such that the support structure is produced integrally, i.e. is an integrally produced and thus single-piece body.

To enable the electrical energy store to be repaired in a particularly advantageous manner, in particular in the event of damage to the lower base element, it is provided in a further design of the invention that, along a first direction that is parallel to a plane in which the upper base element, in particular a surface of the upper base element that faces toward the storage cells, extends, respective side walls of the store housing adjoin the storage cells on both sides. For example, when the electrical energy store is in the installed position, the said first direction coincides with the transverse direction of the motor vehicle. In particular, when the electrical energy store is in the installed position, the said surface of the upper base element faces upward toward the storage cells, in the vertical direction of the vehicle.

The respective side wall extends away from the upper base element in a second direction that is oblique or perpendicular to the plane and extends away from the lower base element and away from the upper base element. Thus, when the electrical energy store is in the installed position, the respective side wall extends upward away from the upper base element in the vertical direction of the vehicle. As a result, the storage cells, as viewed along the first direction, are at least partially, in particular at least predominantly or completely, overlapped on both sides by the respective side walls. Thus, for example, the side walls and the upper base element form a tray, also referred to as a housing tray or receiving tray or battery tray, in which the storage cells are each at least partially, in particular at least predominantly or completely, accommodated. In particular, it is conceivable for the aforementioned receiving region, as viewed along the first direction, to be delimited on both sides, in particular directly, by the side walls. In particular, the tray enables the lower base element to be detached and removed from the upper base element, in particular from the tray, without damaging or destroying the lower base element or the tray and, in particular, while the tray and, in particular via the tray, the storage cells can remain held on the superstructure of the motor vehicle. A further embodiment is characterized in that a respective sub-region of the support structure, as viewed along the first direction, is arranged between the respective side wall and the storage cells, with the result that the storage cells are supported or can be supported on both sides along the first direction, via the sub-regions of the support structure, on the side walls. In particular, it is conceivable for the sub-regions of the support structure to be realized as a single piece with the aforementioned intermediate region of the support structure, such that preferably the sub-regions of the support structure and the intermediate region of the support structure are formed from a single piece and are thus formed by a monoblock or realized as a monoblock. It is thereby possible to realize particularly advantageous supporting, and in particular holding, of the support structure, such that a particularly advantageous accident behavior and a particularly high degree of rigidity of the energy store may be realized. In addition, the energy store can thus be repaired in a particularly advantageous manner.

In particular due to or in the case of the support structure being designed as the said monoblock, it is conceivable for the storage cells to be foam-bonded, through the support structure, i.e. through the sub-regions and the intermediate region, to the store housing, in particular to side walls and to the upper base element, which is also referred to as the lower chord or realized as the lower chord.

To enable a particularly advantageous accident behavior to be realized in a particularly weight-efficient manner, it is provided in a further design of the invention that the respective sub-region of the support structure has a plurality of mutually successive and mutually spaced ribs, as viewed along a spacing direction extending perpendicularly to the said plane, that preferably each have, in particular exactly, one free end. In particular, it is conceivable in this case for the free ends to be mutually spaced along the spacing direction. It is also conceivable that the free ends, along the first direction, can be supported or are supported at least indirectly, in particular directly, on the respective side wall.

To enable the electrical energy store to be repaired particularly easily, it is provided in a further design of the invention that the side walls of the store housing are realized as a single piece with the upper base element. This means that the side walls and the upper base element are formed from a single piece and are thus formed by a monoblock or realized as a monoblock. In other words, it is preferably provided that the side walls and the upper base element are not composed of a plurality of parts realized separately from each other and connected to each other, but preferably the side walls and the upper base element are formed from a single piece, thus realized integrally or formed by an integrally realized or produced body.

In a further design of the invention, it is provided that the storage cells are adhesive-bonded to the support structure, in particular to the intermediate region of the support structure, in particular directly, and/or connected by means of a foam. The foam may be, for example, a PU foam (PU-polyurethane). This allows the storage cells to be interfaced in a particularly advantageous manner to the support structure and, via this, to the upper base element, such that, for example, when the lower base element is being replaced, the upper base element and the storage cell, as well as the support structure, can remain attached to the superstructure.

To enable the electrical energy store to be repaired in a particularly advantageous manner, it is provided in a further design of the invention that the storage cells are connected to the upper base element via at least one respective adhesive connection and/or by a foam. The storage cells can thereby remain attached to the superstructure, in particular via the upper base element, and the upper base element can also thereby remain attached to the superstructure, while the lower base element is being detached or separated from the upper base element, from the cells and from the superstructure and, for example, replaced. The foam may be PU foam.

Finally, it has been shown to be particularly advantageous if the upper base element is made of a fiber-reinforced plastic. In particular, the upper base element, or the fiber-reinforced plastic, is made of SMC (sheet molding compound), making it possible to achieve a particularly high degree of rigidity of the electrical energy store in a particularly weight-efficient manner. In particular, the connection of the additional, lower base element enables the upper base element to be made of the fiber-reinforced plastic, as the connection of the two base elements, for example, makes it possible to achieve an advantageously high degree of robustness of the electrical energy store.

The upper base element may be realized, for example, in such a way that, in particular when the electrical energy store is in the installed position, the storage cells are each completely covered and thus overlapped by the upper base element toward the lower base element, as viewed downward in the vertical direction of the vehicle.

It is also contemplated for the upper base element to be perforated. This is to be understood to mean, in particular, that the upper base element has through-openings. In particular, it is conceivable for the upper base element has at least or exactly one through-opening per storage cell. In particular in this case, it is conceivable for the respective storage cell, in particular a respective cell housing of the respective storage cell, to have a predetermined breaking point formed, for example, by a rupture disc or in another manner, that also acts as a predetermined failure point. If, for example, a pressure increase occurs in the respective cell housing, in particular as a result of a thermal event, the respective cell housing first fails, in particular bursts or ruptures, at the predetermined breaking point, such that, for example, gas, in particular hot gas, can emerge from the respective cell housing at the respective predetermined breaking point. In particular, it is conceivable in this case for the respective predetermined breaking point, in particular when the electrical energy store is in the installed position, to be at least partially, in particular at least predominantly or completely, overlapped toward the lower base element, as viewed downwards in the vertical direction of the vehicle, by the through-opening of the upper base element belonging to the respective storage cell. Thus, the gas emerging from or flowing out of the respective cell housing at the predetermined breaking point can flow, for example, through the respective through-opening of the upper base element belonging to the respective storage cell, such that a specific and thus secure routing or removal of the gas, also referred to as venting, can be achieved.

Finally, it has been shown to be particularly advantageous if there is a foam such as, for example, a PU foam arranged under the storage cells, i.e. between the storage cells and the base, in particular between the cells and the upper base element. It is thereby possible to realize particularly advantageous propagation protection, electrical insulation of the cells and protection against short circuits in the case of degassing.

A second aspect of the invention relates to a motor vehicle, preferably realized as an automobile, in particular as a passenger car, that comprises an electrical energy store according to the first aspect of the invention. Advantages and advantageous designs of the first aspect of the invention are to be regarded as advantages and advantageous designs of the second aspect of the invention and vice versa.

Further details of the invention are given in the following description of preferred exemplary embodiments in conjunction with the associated drawings.

### BRIEF DESCRIPTION OF THE DRAWINGS

FIG. 1 is a schematic sectional view of part of a first embodiment of an electrical energy store for a motor vehicle;

FIG. 2 is a schematic sectional view of part of a second embodiment of the electrical energy store;

FIG. 3 is a schematic sectional view of part of a third embodiment of the electrical energy store; and

FIG. 4 is a schematic sectional view of part of a fourth embodiment of the electrical energy store.

In the figures, elements that are the same or have the same function are denoted by the same reference designations.

### DETAILED DESCRIPTION OF THE DRAWINGS

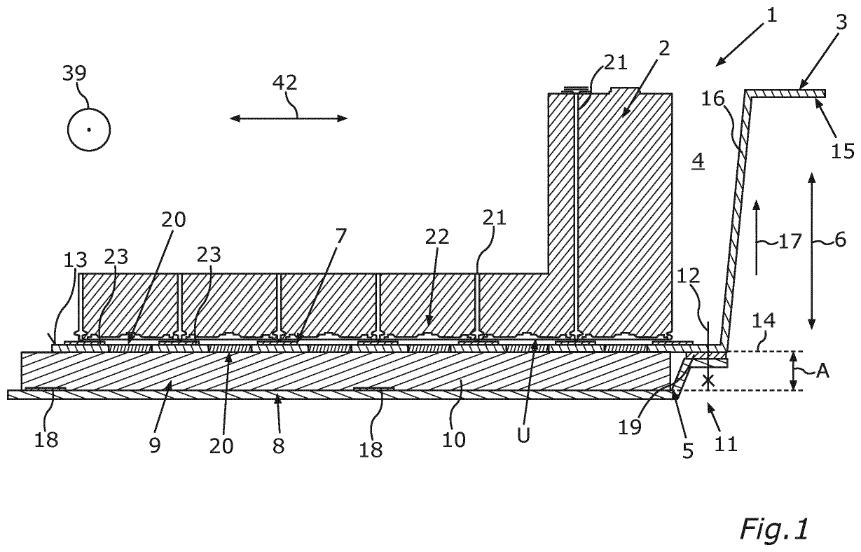

FIG. 1 shows a schematic sectional view, along a sectional plane, of part of an electrical energy store 1 for a motor vehicle realized in particular as an automobile, most particularly as a passenger car. This means that the motor vehicle, also referred to simply as a vehicle, in its completed production state, comprises the electrical energy store 1, which is also referred to simply as a store, energy store or high-voltage store (HVS). The electrical energy store 1 has storage cells 2, which are also referred to as cells or individual cells. The storage cells 2 are individual components realized separately from each other. For example, the storage cells 2 are electrically connected to each other. Electrical energy is to be stored or is stored, in particular electrochemically, in the storage cells 2, i.e. by means of the storage cells 2. The electrical energy store 1 also has a store housing 3 that has, in particular directly delimits, a receiving region 4, also referred to as a receiving space or realized as a receiving space. The storage cells 2 are each arranged, and thus accommodated, at least partially, in particular at least predominantly and thus by at least more than half or, alternatively, completely, in the receiving region 4 and thus in the store housing 3. The store housing 3 has a base 5, also referred to as the housing base, by which, for example, the receiving region 4 is at least predominantly, in particular completely, overlapped downward in the vertical direction of the vehicle when the electrical energy store is in the installed position 1. The electrical energy store 1 assumes its installed position when the motor vehicle is in its completed production state, equipped with the electrical energy store 1, the installed position of the electrical energy store 1 being shown in FIG. 1. The said vertical direction of the motor vehicle is indicated in FIG. 1 by a double arrow 6.

In the first embodiment shown in FIG. 1, the base 5 has a sandwich construction, such that the base 5 and thus the sandwich construction comprise an upper base element 7 and a lower base element 8. In the sandwich construction, the lower base element 8 is arranged at a distance A from the upper base element 7, forming an interspace 9 arranged, in the vertical direction of the vehicle, between the base elements 7 and 8, the distance A extending in the vertical direction of the vehicle, in particular parallel to the vertical direction of the vehicle (double arrow 6). In the first embodiment, arranged in the interspace 9 there is an energy absorption element 10, which is also referred to as a deformation element or defo element and which can be deformed by the dissipation or absorption of energy when a force is applied as a result of an accident. This means that, for example in the case of the aforementioned application of force as a result of an accident, the energy absorption element 10 undergoes deformation, as a result of which accident energy is converted into deformation energy and thus absorbed. In particular, the energy absorption element 10 is realized separately from the base elements 7 and 8. For example, the energy absorption element 10 can be supported or is supported, in particular upwardly in the vertical direction of the vehicle, on the base element 7, in particular at least indirectly, and most particularly directly. It is also contemplated that the energy absorption element 10 can be supported or is supported upwardly in the vertical direction of the vehicle, at least indirectly, in particular directly, on the base element 8. In the present case, i.e. in the first embodiment, the energy absorption element 10 bears directly against each of the base elements 7 and 8. For example, the energy absorption element 10 is made of a foam, also referred to as structural foam, and is thus realized as a foam element. It can be seen that the base elements 7 and 8 are cover elements of the sandwich construction that are mutually spaced apart in the vertical direction of the vehicle. The energy absorption element 10 is arranged, as the core element of the sandwich construction, between the cover elements. A particularly rigid and weight-optimized structure of the base 5 can thus be achieved.

To then enable the energy store 1 to be repaired particularly easily and cost-effectively, for example if the base element 8 has been damaged while the base element 7 and the storage cells 2 are still intact, the base elements 7 and 8, realized separately from each other, can be detached in a non-destructive manner, at least with regard to the base elements 7 and 8, and are thus connected to each other, for example at least indirectly or directly. In the embodiment shown in FIG. 1, the base elements 7 and 8 are screwed together, in particular directly, and thus connected to each other so as to be detachable in a non-destructive manner. This is to be understood to mean, in particular, that the base elements 7 and 8 are screwed together by means of at least one or preferably a plurality of screwed connections 11, in particular directly, and are thus connected to each other so as to be detachable in a non-destructive manner. The screwed connection 11 has a screw element 12 realized, for example, as a screw that penetrates, for example, a corresponding first screw opening of the base element 8. It is conceivable for the base element 7 to have a second screw opening corresponding to the first screw opening, the screw element 12 penetrating, for example, the second screw opening and/or engaging in the second screw opening. By means of the screw element 12, the base elements 7 and 8 are screwed together and thus connected to each other so as to be detachable in a non-destructive manner. Provided for this purpose, for example on the base element 7, there is a thread, in particular an internal thread, corresponding to the screw element 12, to which, for example, the screw element 12 is screw-connected, in particular into which the screw element 12 is screwed, such that the base elements 7 and 8 are screwed together.

The base element 8 is made, for example, of a metallic material, such that the base element 8 is preferably realized as a first base plate. The base element 8 is made is made, for example, of steel or aluminum. It is conceivable for the base element 7 to be made of a metallic material and thus to be realized as a second base plate. For example, the base element 7 is made of steel or aluminum. It has been shown to be particularly advantageous, however, if the base element 7 is made of a fiber-reinforced plastic, in particular SMC.

The base element 7, in particular its surface 13 that faces toward the storage cells 2 and thus extends upward in the vertical direction of the vehicle and away from the lower base element 8 and the energy absorption element, extends in a notional plane 14 that, for example, is perpendicular to the vertical direction of the vehicle. In FIG. 1, a first direction is indicated by a double arrow 42, with the first direction being parallel to the notional plane 14 and thus, in particular, perpendicular to the vertical direction of the vehicle. In particular, the first direction indicated by the reference numeral 42 extends in the transverse direction of the vehicle, in particular parallel to the transverse direction of the motor vehicle, such that the transverse direction of the motor vehicle is indicated by the double arrow 42. The aforementioned sectional plane is thus spanned, for example, by the transverse direction of the vehicle and the vertical direction of the vehicle.

In the first embodiment, the base element 7 is a constituent part of a tray 15, also referred to as a housing tray, of the store housing 3. It is provided in this case that, along the first direction (double arrow 42), respective side walls of the tray 15, and thus of the store housing 3, adjoin the storage cells 2 on both sides.

Of the aforementioned side walls of the tray 15, one of the side walls is visible and denoted by 16. As can be seen from the example of the side wall 16, the respective side wall of the tray 15 extends in a second direction, indicated by an arrow 17, that extends obliquely or perpendicularly to the plane 14 and away from the base elements 7 and 8, and thus, as it were, upwardly in the direction of the vehicle away from the upper base element 7, as a result of which the storage cells 2, as viewed along the first direction (double arrow 42), are in each case at least partially, in particular at least predominantly and thus by at least more than half or completely, overlapped on both sides by the respective side walls of the tray 15. In particular, it can be seen from FIG. 1 that the receiving region 4 is overlapped, in particular directly delimited, on both sides along the first direction (double arrow 42) by the side walls of the tray 15. It is therefore provided that the side walls of the tray 15 are realized as a single piece with the upper base element 7, such that the side walls of the tray 15 and the upper base element 7 of the tray 15 are formed from a single piece, i.e. are formed by an integrally produced or integrally formed body. It is therefore conceivable for the side walls of the tray 15 to be made of the metallic material of which the base element 7 is made, or for the side walls to be made of the fiber-reinforced plastic of which the base element 7 is made.

In the first embodiment, the energy absorption element 10 is adhesive-bonded, in particular directly, to the base element 8. For this purpose, indicated in FIG. 1, represented in a particularly form, are at least one or more adhesive connections 18, by means of which the energy absorption element 10 is adhesive-bonded, in particular directly, to the base element 8. It is conceivable for the energy absorption element 10 not to be directly connected to the upper base element 7.

In the first embodiment, the electrical energy store 1 has a sealing element 19 arranged in particular, in the vertical direction of the vehicle, between the base elements 7 and 8 and, for example, realized separately from the base elements 7 and 8, by means of which the base elements 7 and 8 are sealed with respect each other, in particular in such a way that the sealing element 19 bears both, in particular directly, against the base element 7 and, in particular directly, against the base element 8. In particular, the sealing element 19 is clamped between the base elements 7 and 8. In the first embodiment, the screw element 12 also penetrates the sealing element 19. In the first embodiment, the base element 7 is perforated. Thus, the base element 7, in particular for each storage cell 2, has at least or exactly one through-opening 20. It can be seen that the respective storage cell 2 has a respective cell housing 21. For example, there are at least or exactly two electrodes of the respective storage cell 2 arranged in the respective cell housing 21. For example, the respective cell housing 21 has at least or exactly one predetermined breaking point 22, which in the first embodiment is arranged, for example, on a respective underside U of the respective cell housing 21 that faces downward in the vertical direction of the vehicle. It is conceivable in this case for the respective predetermined breaking point 22 to be at least partially, in particular at least predominantly or completely, overlapped downwardly in the vertical direction of the vehicle, and thus toward the lower base element 8, by the respective through-opening 20 of the upper base element 7. The respective through-opening 20 is arranged at a respective site on the upper base element 7. As an alternative to the respective through-opening 20, a thinned portion of the material of the base element 7 may be provided, for example, in particular at the respective site. The thinned portion of the material is to be understood to mean that the base element 7 is thinner, for example, at the respective site than in other regions, and thus has a first wall thickness that is, for example, less than a second wall thickness in a wall region of the base element 7 that in particular directly adjoins the respective site. If, for example, a pressure increase occurs in the respective cell housing 21, in particular as a result of a thermal event, the respective cell housing 21 first fails, in particular bursts or ruptures, at the setpoint breaking point 22. As a result, a gas, in particular a hot gas, can emerge from the respective cell housing 21 at the respective predetermined breaking point 22. For example, the gas can flow through the through-opening 20 and thus be removed from the respective storage cell 2 in a specific manner. It is also conceivable for the hot gas to sever the thinned portion of material, or the upper base element 7, at the aforementioned site and subsequently to flow through the upper base element 7, thereby enabling the gas to be removed in an advantageous manner.

In FIG. 1 there are elements denoted by 23. The respective element 23 is, for example, a cell seating via which, for example, the respective storage cell 2 is supported on the base element 7, in particular in such a way that the cell seating is supported both, in particular directly, on the respective storage cell 2 and, in particular directly, on the base element 7, in particular its surface 13. For example, the cell seating is made of a plastic. Alternatively or additionally, the respective element 23 may be a respective adhesive connection by means of which, for example, the respective storage cell 2 is adhesive-bonded, in particular directly, to the upper base element 7, in particular to the surface 13.

Overall, it can be seen that the lower base element 8 is realized as an assembly part. In the case of servicing or repair, for example, the screw elements 12 are undone. It is also conceivable, for example, for the sealing element 19, which is realized, for example, as a butyl seal, to be severed, with the base element 8 being detached from the base element 7 without damaging or destroying another element. The base element 8 can then be detached and removed from the base element 7 and the storage cells 2, while the tray 15 and the storage cells 2 remain on a superstructure of the motor vehicle realized, for example, as a self-supporting body. After the screw elements 12 have been undone and, in particular, after the sealing element 19 has been severed, the base element 8, for example, is moved away, in particular drawn off, downward in the vertical direction of the vehicle, in particular together with the energy absorption element 10, in particular by lifting, in particular until, for example, plastic plugs, in particular having an undercut, are disengaged. By means of the aforementioned plastic plugs, in particular by the formation of the aforementioned, in particular resilient undercut, for example the energy absorption element 10 is fastened to the tray 15, in particular to the base element 7.

The adhesive connection 18 is formed, for example, by an adhesive strip. For example, at least or exactly four adhesive connections 18 are provided. In other words, the number of the adhesive connections 18 may be in a range of from 1 to 4, inclusively. For example, in the first embodiment, the base element 8 is screw-connected, circumferentially in the circumferential direction of the base element 8 extending around the vertical direction of the vehicle by means of the screw elements 12, in particular to the tray 15, and sealed with respect to the tray 15, in particular with respect to the base element 7, in particular by means of the sealing element 19. It is also conceivable for the energy absorption element 10 is fastened to the tray 15 by means of the aforementioned plastic plugs, in particular in between a respective cell triangle. The previously described removal of the gas from the respective cell housing 21 is also referred to as venting. The gas is directed, for example, into the interspace 9, in particular via the perforated base element 7. There are holes provided at the rear, for example, in order to direct the gas, in particular its flow, also referred to as gas flow, from the interspace 9, which is used as a deformation zone, to another region and thus to enable it to be removed in a specific manner.

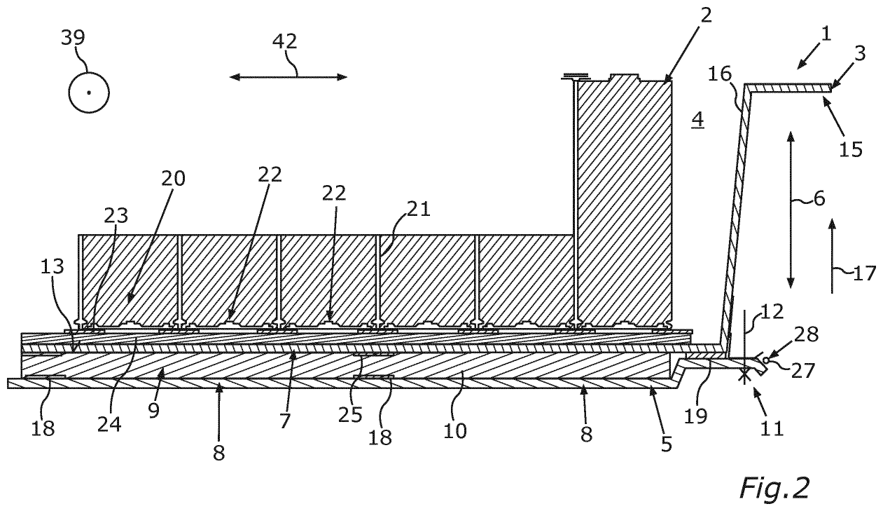

FIG. 2 shows a schematic sectional view, in particular along the aforementioned sectional plane, of part of a second embodiment of the energy store 1. Provided in the second embodiment is a structural element 24 via which the storage cells 2 are supported on the upper base element 8, in particular downwardly in the vertical direction of the vehicle. The structural element 24 is realized, for example, separately from the base element 8. In particular, the structural element 24 is arranged, in particular in the vertical direction of the vehicle, between the storage cells 2 and the base element 8. The structural element 24 is, for example, a degassing structure, the aforementioned gas being able flow out of the respective storage cell 2 and, in particular, flow into the degassing structure. By means of the degassing structure, for example the gas from the respective cell housing 21 can be removed from the respective cell housing 21 in a selective manner. For example, the structural element 24 is made of a plastic, in particular a fiber-reinforced plastic. The structural element 24 may therefore be a plastic structure, for example. It is conceivable for the storage cells 2 to be adhesive-bonded to the base element 8 via the structural element 24. In particular, the structural element 24 may be a compact plastic support, which may be made of the aforementioned plastic, in particular fiber-reinforced plastic. For example, the respective storage cell 2 is adhesive-bonded, in particular directly, to the structural element 24, in particular by means of the respective element 23. Alternatively or additionally, for example, the structural element 24 may be adhesive-bonded, in particular directly, to the upper base element 8, in particular to its surface 13. In particular, it is conceivable for the structural element 24 to be made of SMC (sheet molding compound), such that the aforementioned fiber-reinforced plastic may be SMC.

It is conceivable that the aforementioned cell seating may also be pressed into the structural element 24, in particular into its fiber-reinforced plastic, or into the upper base element 8, in particular into its fiber-reinforced plastic, such that, for example, there is no need for a separate support structure such as the structural element 24. A degassing structure, in particular having degassing channels, through which the gas can flow, to guide the gas away from the storage cells 2, may in this case be integrated into the fiber-reinforced plastic, in particular into the aforementioned SMC, in particular of the base element 8 or of the structural element 24.

In the second embodiment, shown in FIG. 2, the structural element 24 is a support structure made of the aforementioned plastic, in particular of the aforementioned fiber-reinforced plastic, the structural element 24 comprising the aforementioned degassing structure with the degassing channels. The structural element 24 and the base element 8 in this case are components that are realized separately from each other and are supported at least indirectly, in particular directly, against each other, and that in the present case are supported at least indirectly, in particular directly, against each other in the vertical direction of the vehicle. In particular, for example the base element 8 is connected, in particular adhesive-bonded, in particular directly, to the structural element 24. As an alternative to using the additional structural element 24, it is conceivable that the separate support structure formed by the structural element 24 may be omitted, in particular if the base element 8 is made of the aforementioned fiber-reinforced plastic, in particular of SMC, such that, for example, a cell seating is then pressed into the fiber-reinforced plastic of the base element 8, whereby, for example, the fiber-reinforced plastic of the base element 8 forms the degassing structure with the degassing channels.

When the energy store 1 according to the second embodiment is being assembled, for example the energy absorption element 10 is pre-fastened to the base element 8, in particular by means of the respective adhesive connection 18, before the base element 8 is connected to the base element 7. In this case, for example, the energy absorption element 10 is surface-bonded to the base element 8 by means of the respective adhesive connection 18, for example formed by a respective adhesive strip, and thereby pre-fastened to the base element 8. In particular, the base element 8 is then screw-connected and thereby connected, at least indirectly and so as to be detachable in a non-destructive manner, to the base element 7 and sealed, in particular circumferentially. In the second embodiment, the screwed connection of the base element 8 to the tray 15 by means of the screw element 12 is effected, for example, in such a way that a local holder 26 is provided, in particular for each screwed connection 11. The holder 26 is realized, for example, as a single piece with the tray 15, or the holder 26 is realized separately from the tray 15 and connected, in particular welded, to the tray 15, in particular to the side wall 16. The base element 8 in this case is screw-connected, in particular directly, to the holder 26 and, via the holder 26, to the base element 7 and thereby connected, resulting in the base element 8 being connected to the base element 7 in a non-destructively detachable manner. It can be seen that the screw element 12 penetrates the base element 8, and the screw element 12 penetrates the holder 26 or engages in the holder 26. In particular, the aforementioned thread corresponding to the screw element 12 is provided on the holder 26 and thus, via the holder 26, on the base element 7.

In order to detach the base element 8 from the base element 7 and for this purpose to sever the sealing element 19, which in particular is made of butyl, a cutting element 27, realized as a cutting wire or cutting line, is provided, which may be a constituent part of the energy store 1 and may be held at least indirectly on the tray 15 and/or the base element 8. Also provided is an insertion aid 28, which in the present case is partially delimited by the holder 26 and partially by the base element 8. The cutting element 27 can be inserted into the insertion aid 28, in particular along the first direction indicated by the double arrow 42, as a result of which the cutting element 27 is guided between the base elements 7 and 8 and, in particular, to the sealing element 19 by means of the insertion aid 28. Further movement of the cutting element 27 along the first direction causes the sealing element 19 to be severed by means of the cutting element 27, resulting in the base elements 7 and 8 being detached from each other in a non-destructive manner with regard to the base elements 7 and 8.

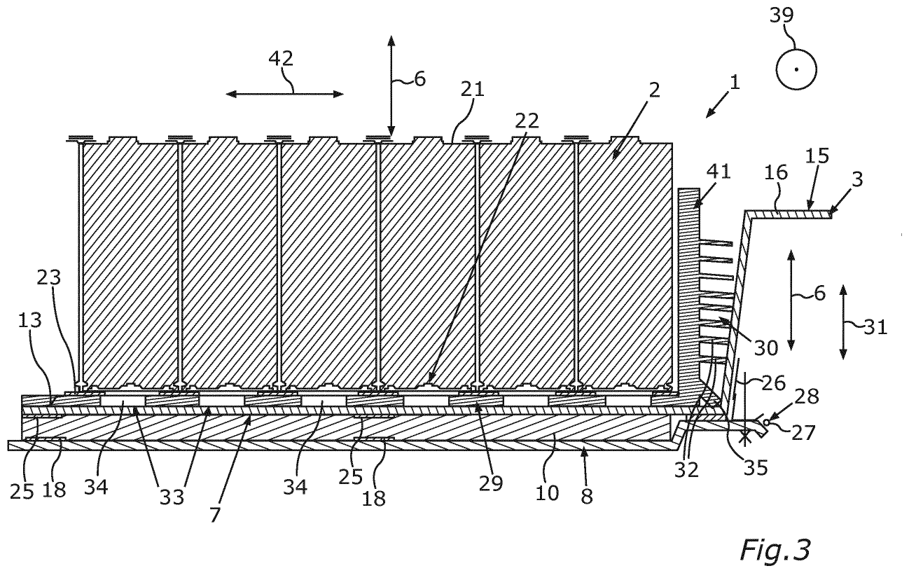

FIG. 3 shows a schematic sectional view, in particular along the aforementioned sectional plane, of part of a third embodiment of the energy store 1. In the third embodiment, the energy store 1 has a support structure that in the present case is realized as a plastic structure 41. This means that in the present case the support structure is made of a plastic. Alternatively, it would be conceivable for the support structure to be made of a metallic material, such that the support structure is realized as a metal structure. In the present case, the plastic structure 41 is a structure made of a plastic, in particular a fiber-reinforced plastic, and is also referred to as a plastic element or plastic device. The storage cells 2, in particular in the vertical direction of the vehicle, are supported on the upper base element 7, in particular on its surface 13, via the plastic structure 41 realized separately from the storage cells 2 and separately from the base element 7 and also separately from the base element 8, in particular in such a way that the plastic structure 41 is supported, in particular directly, on the base element 7, in particular on the surface 13. It is also conceivable for the plastic structure 41 to be supported, in particular directly, on the storage cells 2. In the third embodiment, the plastic structure 41 has an intermediate region 29 that, for example, forms or is the structural element 24 with respect to the second embodiment. In the third embodiment, the storage cells 2 are supported above the intermediate region 29, in particular in the vertical direction of the vehicle (double arrow 6), on the upper base element 7, in particular on its surface 13. It is conceivable for the intermediate region 29 to be supported, in particular directly, on the base element 7, in particular on the surface 13. It is also conceivable for the intermediate region 29 to be supported, in particular directly, on the storage cells 2. In the third embodiment, the intermediate region 29 is adhesive-bonded, in particular directly, to the storage cells 2, in particular by means of the respective element 23 realized as an adhesive connection. Alternatively or additionally, for example the intermediate region 29 may be adhesive-bonded, in particular directly, to the base element 7, in particular to the surface 13.

In the third embodiment, it is likewise provided that, in particular along the first direction indicated by the double arrow 42, there is a respective sub-region 30 of the plastic structure 41 arranged between the respective side wall of the tray 15 and the storage cells 2, such that the sub-regions of the plastic structure 41 adjoin the storage cells 2 on both sides along the first direction indicated by the double arrow 42. The storage cells in this case are at least partially, in particular at least predominantly or completely, overlapped, along the first direction and thus toward the side walls, on both sides by the sub-regions of the plastic structure 41. As a result, the storage cells 2 can be supported or are supported on both sides along the first direction via the sub-regions of the plastic structure 41 on the side walls of the tray 5. In the third embodiment, as can be seen from the example of the sub-region 30, the respective sub-region of the plastic structure 41 on the one hand can be supported or is supported along the first direction, in particular directly, on the storage cells 2, and on the other hand can be supported or is supported, in particular directly, on the side wall.

The sub-region 30 in this case is or forms an energy absorption structure, i.e. a structure for absorbing energy. As can be seen from the example of the sub-region 30 of the plastic structure 41, the energy absorption structure has a plurality of ribs 32 that, as viewed along a spacing direction that is perpendicular to the plane 14, or illustrated in FIG. 3 by a double arrow 31, succeed each other and are mutually spaced. In the present case, the respective rib 32 has a respective free end that faces toward the side wall 16. Via the respective free end, the respective rib 32 can be supported or is supported, along the first direction illustrated by the double arrow 42, in particular directly, on the respective side wall 16. It is also provided that the plastic structure 41 is realized as a single piece. This is to be understood to mean, in particular, that the intermediate region 29 is realized integrally with sub-regions 30 of the plastic structure 41, such that the intermediate region 29 and the sub-regions 30 of the plastic structure 41 are formed from one single piece, and are thus realized integrally or are formed by an integrally realized or produced body.

Furthermore, it can be seen from FIG. 3 that a device 33 of the electrical energy store 1 is arranged at least partially in the intermediate region 29. In particular, the device 33 is realized separately from the intermediate region 29, in particular from the plastic structure 41. It can be seen that the device 33 has channels 34, the device 33 being arranged in particular, in the vertical direction of the vehicle, between the storage cells 2 and the upper base element 7, in particular on the surface 13. Thus, the respective channel 34 is arranged, in the vertical direction of the vehicle, between the storage cells 2 and the base element 7, in particular at the surface 13. The device 33 may be, for example, a ventilation device also referred to as a venting structure or venting device. For example, the aforementioned gas flowing out of the respective cell housing 21 can flow into the respective channel 34, whereupon the gas is removed from the respective storage cell 2 by means of the respective channel 34. For this purpose, it is provided in particular that the respective predetermined breaking point 22 is overlapped, downward in the vertical direction of the vehicle and thus toward the lower base element 8, at least partially, in particular at least predominantly or completely, by the respective channel 34. Alternatively or additionally, it is conceivable for the device 33 to be a temperature control device, in particular a cooler, in which case the storage cells 2 may be temperature-controlled, i.e. cooled and/or heated, by means of the temperature control device. In this case, for example, a fluid temperature control agent, by means of which the temperature of the storage cells 2 can be controlled, i.e. cooled and/or heated, in particular via the device 33, can flow through the respective channel 34. In this way, in particular, a heat exchange between the storage cells 2 and the temperature control medium may be effected via the device 33. For example, the plastic structure 41, in particular the intermediate region 29 and/or the sub-region 30, is supported over its surface on and/or at the device 33, in particular in the cooler, and/or the respective storage cell 2.

It can be seen from FIG. 3 that in the third embodiment the structure for energy absorption has a rib 35 that is thicker than the ribs 32. For example, the rib 35 forms a structure for misuse and/or venting, in particular in the event of an accident.

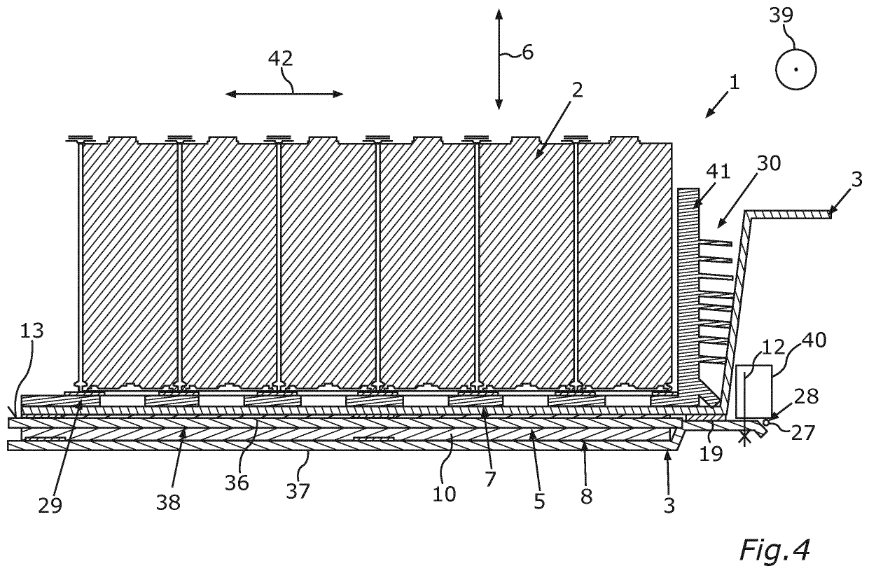

Finally, FIG. 4 shows a fourth embodiment of the energy store 1. The fourth embodiment is characterized in particular by the fact that the lower base element 8 is double-walled, and in this case has two walls 36 and 37, that are mutually spaced apart in the vertical direction of the vehicle, forming an interspace 38 arranged between the walls 36 and 37 in the vertical direction of the vehicle. The energy absorption element 10 is arranged in the interspace 38, and thus, in the vertical direction of the vehicle, between the walls 36 and 37. There is no further energy absorption element, in particular no further structural element of the electrical energy store 1, arranged between the upper wall 36 and the upper base element 7 in the vertical direction of the vehicle. For example, the energy absorption element 10 is supported, in particular in the vertical direction of the vehicle, in particular directly, on the wall 36 and/or on the wall 37.

The aforementioned superstructure of the motor vehicle, preferably realized as a self-supporting body, has two side skirts mutually spaced apart in the transverse direction of the vehicle, the respective directions of longitudinal extent of which extend in the longitudinal direction of the vehicle. The longitudinal direction of the vehicle is indicated by a double arrow 39. One of the side skirts can be seen in FIG. 4 and is denoted by 40. It can be seen that in the fourth embodiment, the lower base element 8 is screw-connected, in particular directly, to the side skirt 40 by means of the respective screw element 12, and is thus held on the side skirt 40, such that the lower base element 8 is indirectly connected to the upper base element 7 in a non-destructively detachable manner. In this case, the screw element 12 penetrates the corresponding screw opening of the base element 8, for example realized as a through-opening. The screw element 12 also, for example, penetrates a corresponding screw opening of the side skirt 40, in particular realized as a through-opening, or the screw element 12 engages in a screw opening of the side skirt 40, which is also referred to simply as an opening. In an embodiment that is not shown in the figures, the electrical energy store 1 may optionally comprise a film, in particular for internal sealing.

As in the third embodiment, the sub-region 30 of the plastic structure 41 may be used for a side impact, for example to enable accident-related loads to be absorbed and supported, and in particular absorbed, by deformation of the sub-region 30, in particular if an accident-related force acts inwards upon the electrical energy store 1 in the transverse direction of the vehicle as a result of an accident. In the fourth embodiment also, the cutting element 27 is provided to sever the sealing element 19. In the fourth embodiment, the insertion aid 28 is partially delimited by the side skirt 40 and partially by the base element 8. The insertion aid 28 is formed in particular by the fact that the insertion aid 28 extends in a funnel shape in the transverse direction of the vehicle, or inwardly along the first direction. In order to realize a particularly advantageous energy absorption, it is preferably provided that the plastic structure 41, in particular the intermediate region 29 and/or the sub-region 30, has a honeycomb structure having a plurality of, in particular hexagonal, honeycombs.

### LIST OF REFERENCE DESIGNATIONS

1 electrical energy store
2 storage cells
3 store housing
4 receiving region
5 base
6 double arrow
7 upper base element
8 lower base element
9 interspace
10 energy absorption element
11 screwed connection
12 screw element
13 surface
14 plane
15 tray
16 side wall
17 arrow
18 adhesive connection
19 sealing element
20 through-opening
21 cell housing
22 predetermined breaking point
23 element
24 structural element
25 adhesive connection
26 holder
27 cutting element
28 insertion aid
29 intermediate region
30 sub-region
31 double arrow
32 rib
33 device
34 channel
35 rib
36 wall
37 wall
38 interspace
39 double arrow
40 side skirt
41 plastic structure
42 double arrow
A distance
U underside

1.-11. (canceled)

12. An electrical energy store for a motor vehicle, comprising:
storage cells that store electrical energy;
a store housing in which the storage cells are arranged, wherein
the store housing comprises a base formed of a separate upper and a lower base element,
the separately formed upper and lower base elements are configured to be detachable from each other in a non-destructive manner, at least with regard to non-destruction of the upper and lower base elements.

13. The electrical energy store according to claim 12, wherein
the storage cells are supported on the upper base element via a support structure arranged between the upper base element and the storage cells.

14. The electrical energy store according to claim 13, wherein
along a first direction that is parallel to a plane in which the upper base element extends, the storage cells are adjoined on both sides by respective side walls of the store housing,
each respective side wall extends away from the upper base element in a respective second direction that extends obliquely or perpendicularly to the plane and away from the lower base element and from the upper base element, as a result of which the storage cells, as viewed along the first direction, are overlapped on both sides by the respective side walls.

15. The electrical energy store according to claim 14, wherein
a respective sub-region of the support structure is arranged along the first direction between the respective side wall and the storage cells, as a result of which the storage cells are supported on both sides along the first direction, via the sub-regions of the support structure, on the side walls.

16. The electrical energy store according to claim 15, wherein
the respective sub-region of the support structure has a plurality of mutually successive and mutually spaced ribs, as viewed along a spacing direction extending perpendicularly to the plane.

17. The electrical energy store according to claim 14, wherein
the side walls are formed as a single piece with the upper base element.

18. The electrical energy store according to claim 13, wherein
the storage cells are adhesive-bonded to the support structure and/or connected to the support structure via a foam.

19. The electrical energy store according to claim 12, wherein
the storage cells are connected to the upper base element via at least one respective adhesive connection and/or by foam.

20. The electrical energy store according to claim 12, wherein
the upper base element is made of a fiber-reinforced plastic.

21. The electrical energy store according to claim 12, wherein
a foam is arranged between the storage cells and the base.

22. A motor vehicle comprising an electrical energy store according to claim 12.
